(19) United States
(12) Patent Application Publication
(10) Pub. No.: US 2013/0218489 A1
(43) Pub. Date: Aug. 22, 2013

(54) Method For Monitoring The Condition Of A Fluid

(71) Applicant: Frederick P. Boyle, Kirtland, OH (US)

(72) Inventor: Frederick P. Boyle, Kirtland, OH (US)

(73) Assignee: THE LUBRIZOL CORPORATION, Wickliffe, OH (US)

(21) Appl. No.: 13/882,742

(22) PCT Filed: Nov. 16, 2011
(86) PCT No.: PCT/US11/60892

§ 371 Date: May 1, 2013

Related U.S. Application Data
(60) Provisional application No. 61/415,949, filed on Nov. 22, 2010.

(51) Int. Cl. G01D 21/02

(52) U.S. Cl. CPC G01D 21/02
USPC 702/50

(57) ABSTRACT

A method for filtering condition measurements made of a fluid used in transportation and industrial equipment that operates in varying state to meet performance requirements. Equipment operating state is monitored by fluid temperature without need for further input.

### FIELD OF THE INVENTION

The present invention relates to methods of monitoring the condition of a fluid, where the methods utilize a novel means of filtering measurements made by one or more sensors monitoring the condition of the fluid, where the fluid is in use in transportation or industrial equipment including but not limited to vehicles, machines, devices and the like. The invention has particular benefit for on-line monitoring and analysis of properties of fluids in equipment that operate at varying speeds or loads, for example monitoring and analysis of a lubricant used in an internal combustion engine for an on-highway application. More specifically, the invention includes embodiments that have benefits in monitoring level and impedance changes of an engine lubricant and in determining when the lubricant is no longer adequate for optimum engine performance and life.

### BACKGROUND OF THE INVENTION

Sensors for real-time, on-board measurement of fluid level, electrical, optical or other properties are known in the art. A good overview of sensors used in real-time lubricant diagnosis is given in “Determining Proper Oil and Filter Change Intervals: Can Onboard Automotive Sensors Help?”, Sabrin Khaled Gebarin and Jim Fitch, Practicing Oil Analysis, March-April 2004. Most real-time sensors make repeated brief measurement of a physical or chemical fluid property, and provide an output that is either the measured property or a function of the measured property. In general, the real-time sensors work best for fluids used in equipment and applications where the equipment operates at steady-state such that fluid level and circulation remain essentially fixed. Many sensors have a more difficult time giving meaningful fluid condition measurements when equipment operating state changes between measurements.

As an example of an equipment where operating state changes as a function of performance requirement, FIGS. 1 and 2, are graphical representations of fluid temperature measurements versus calendar time and versus equipment “on” time respectively, for an engine lubricant in a diesel powered delivery truck. Temperature was measured by a sensor at approximately one minute intervals during the approximately 56 hours that the truck ignition switch was “on” during the five day period shown. In general, lubricant temperature and the rate of lubricant temperature change is a function of engine speed and load. At the start of each day, 1, 3, 5, 7, 9 (similar features are labeled the same in both figures), lubricant temperature rose to an operating temperature with differences in the rate of rise consistent with the truck being operated differently at the start of each day. During each operating day lubricant temperature varied base on the truck's delivery schedule. Gaps in data seen in FIG. 1, for example 11, 13, are periods of engine shutdown, possibly for truck loading or unloading, and long periods of lubricant temperature decrease, for example 15, 17 are typically extended periods of engine idling, again possibly during truck loading or unloading, or may be periods when the truck operator left the ignition switch “on” to power an electrical feature of the truck, for example a radio, but also powering the sensor. Beyond these more pronounced features of FIGS. 1 and 2, other lubricant temperature changes were caused by varying truck load, varying road grade and stop-and-go driving. There are periods of relatively steady-state engine operation, for example 19, 21 and 23, which probably occurred during continuous freeway operation.

While making the temperature measurements of FIG. 2, the same sensor also measured lubricant permittivity and lubricant level at approximately 1 minute intervals as shown in the graphical representations of FIGS. 3 and 4 respectively. Lubricant permittivity is known to be associated with lubricant contamination condition where the contaminant may be soot, water, oxidation by-products or other. Lubricant level is a physical lubricant condition that must be maintained to maximize the lubricant change interval. In general, a lubricant's permittivity and level should show only minor change as a function of run time since contaminants typically increase relatively slowly during use in most applications and lubricant level typically decreases slowly during use due to seal losses, evaporation or consumption. In most steady-state equipment operation there are only minor permittivity and level measurement variations. In an engine with the varying operation shown by lubricant temperature of FIG. 2, permittivity and level show large transient variation even though permittivity measurements of FIG. 3 are normalized to a fixed temperature to minimize temperature dependent variations and both permittivity and level measurements of FIGS. 3 and 4 respectively are filtered to accept only measurements made above 60° C. when absolute rate of temperature change is less than 5° C. per minute to minimize sensor hardware related issues. This filtering caused the periods where permittivity and level changes do not occur, for example the periods generally labeled 19. Note in FIGS. 3 and 4 that permittivity and level respectively show the least variation when the temperature measurements in FIG. 2 show the least variation, for example at the relatively steady-state temperature periods 19, 21. 23 of FIG. 2, permittivity during corresponding periods 27, 29, 31 of FIG. 3 and level during corresponding periods 35, 37, 39 of FIG. 4 show relatively little variation. Permittivity and level, however, show large variation when the temperature variation is largest, for example during the run time when the two long temperature decreases 15, 17 occurred in FIGS. 1 and 2, the corresponding permittivity 33 of FIG. 3 and level 41 of FIG. 4 had large variations.

In order to provide meaningful fluid condition information in “non-steady-state” applications either the sensor or the electronics receiving sensor data must filter measurements to minimize variations. The filtering can be by smoothing using one of many mathematical methods, for example averaging or regression, or can be by using information from other sensors or equipment control units to quantify the equipment operating state. For example, some engine manufacturers filter level sensor data using engine operating state information from the engine-control-unit (ECU) to achieve stable real-time level results. A limitation of smoothing methods is that, in general, smoothing causes time delays when trying to separate actual fluid condition changes from transient measurement variations; the greater the transient variations that must be smoothed, the greater the time delay. A limitation of using other information to filter transient variations is the added cost to either the sensor or the data interpretation unless the other information is present on the sensor. For many sensors fluid temperature data is already available or can be easily incorporated on fluid condition sensors however the art does not include the use of this temperature data in the filtering of other fluid condition measurements as described by the present invention.

Hence, there remains a need for a low cost and time efficient method to minimize the effects of variations in equipment operation state on fluid-condition measurements. Accordingly, the present invention provides a measurement filtering method using only fluid temperature to improve the on-line condition sensing of fluids used in industrial or transportation applications where equipment operating state varies.

### SUMMARY OF THE INVENTION

An object of the present invention is to provide a method for filtering measurements of a sensor monitoring the condition of a fluid in use in transportation and industrial equipment. More specifically, the invention relates to a method of using fluid temperature for filtering sensor measurements used to determine condition of fluid in a transportation or industrial equipment with varying operating states to meet performance requirements. In particular, the invention includes a method that can be used to filter sensor measurements providing real-time monitoring of a lubricant in use in an internal combustion engine.

The invention provides a method of filtering condition measurements of a fluid utilized in a piece of equipment comprising the steps of (i) measuring the temperature of the fluid over time during the operation of the piece of equipment; (ii) measuring at least one fluid condition over time during the operation of the piece of equipment; (iii) filtering the fluid condition measurements by selecting only fluid condition measurements taken during time periods when: (a) the fluid temperature is increasing; or (b) the fluid temperature is not decreasing; and (iv) using the filtered fluid condition measurements in the determination of the condition of the fluid.

The invention further provides for such methods where the measured fluid condition are selected from one or more of the following: a physical property, a chemical property, an electrical property, an optical property, an acoustic property, of combinations thereof

The fluid condition measurements made may be in relation to one fluid condition, or fluid property, or in relation to multiple fluid conditions, or properties, and may be measured by a single sensor or by multiple sensors.

The invention further provides for such methods where the determination of whether the fluid temperature is increasing or not decreasing, is made by comparing the fluid temperature measurement corresponding to the fluid condition measurement in question, to the fluid temperature measurement of the previous corresponding fluid condition measurement, wherein the corresponding fluid temperature measurement is that read during the same equipment operating period that the fluid condition measurement is read.

The methods of the present invention may be applied in an essentially real-time manner, as the measurements are being made. The methods of the invention may be applied at some time after the collection of the measurements, where the measurements have been stored for later fluid condition determination.

The methods may be applied at a location selected from one of the following: at a sensor making a fluid condition measurement, at a sensor making the temperature measurements, at an electronic module that collects essentially real-time fluid condition and temperature measurements, at an electronic module that processes stored fluid condition and temperature measurements, and combinations thereof.

The invention further provides methods, as described above, wherein one or more additional means of filtering the fluid condition measurements are applied. These additional means of filtering are different from the fluid temperature measurement utilizing means of filtering described above.

The invention may be more readily apparent from the figures included in this specification and described in the next sections.

### BRIEF DESCRIPTION OF THE DRAWINGS

FIG. 1 is a graphic representation of engine-lubricant temperature as a function of calendar time during periods when a sensor, monitoring the lubricant, was powered in a delivery truck.

FIG. 2 is a graphic representation of engine-lubricant temperature as a function of time that power was applied to a sensor monitoring the lubricant in a delivery truck.

FIG. 3 is a graphic representation of engine-lubricant permittivity as a function of time that power was applied to a sensor monitoring the lubricant in a delivery truck.

FIG. 4 is a graphic representation of engine-lubricant level as a function of time that power was applied to a sensor monitoring the lubricant in a delivery truck.

FIG. 5 is a flow chart of a feature of the present invention wherein fluid-condition sensor measurements are accepted only when measured fluid temperature is increasing.

FIG. 6 is a flow chart of a feature of the present invention wherein fluid-condition sensor measurements are accepted only when measured fluid temperature is not decreasing.

FIG. 7 is a flow chart of a feature of the present invention wherein fluid-condition sensor measurements can also be rejected by methods in addition to the method of this invention.

FIG. 8 is a flow chart of a feature of the present invention wherein two different fluid condition sensor measurements are made with one measurement accepted only when fluid temperature is increasing and the other measurement accepted only when fluid temperature is not decreasing.

FIG. 9 is a graphic representation of permittivity measurements of FIG. 3 filtered by one embodiment of the present invention.

FIG. 10 is a graphic representation of the permittivity measurements shown in FIG. 3 filtered by a second embodiment of the present invention.

FIG. 11 is a graphic representation of the level measurements shown in FIG. 4 filtered by one embodiment of the present invention.

FIG. 12 is a graphic representation of the level measurements shown in FIG. 4 filtered by a second embodiment of the present invention.

FIG. 13 is a graphic representation comparing the permittivity measurements of FIGS. 3, 9 and 10 each smoothed by the same smoothing method.

FIG. 14 is a graphic representation comparing the level measurements of FIGS. 4, 11, and 12 each smoothed by the same smoothing method.

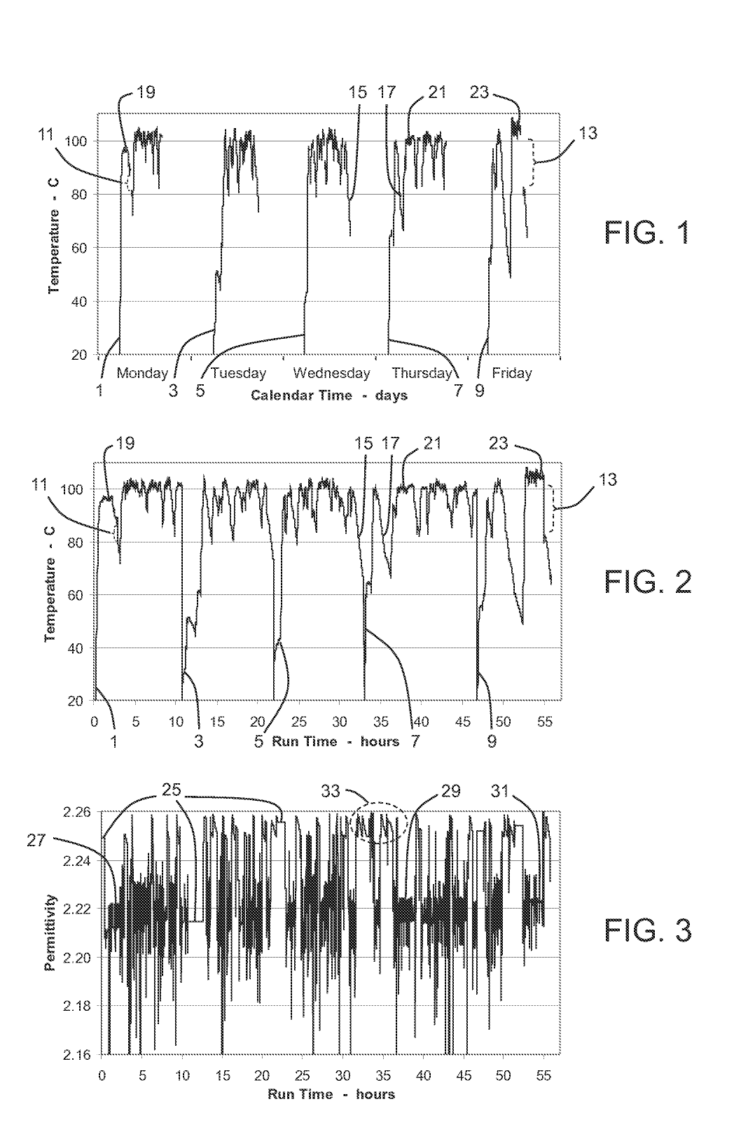

### DETAILED DESCRIPTION OF THE INVENTION

Various preferred features and embodiments are described below by way of non-limiting illustration.

The invention relates to a cost-effective method for filtering measurements of a sensor monitoring the condition of a fluid(s) in transportation and industrial equipment.

FIG. 5 is a flow chart of an embodiment 43 of the present invention for filtering measurements of a sensor monitoring the condition of a fluid. Method 43 begins at block 45 when equipment and sensor are turned “on” at the start of an equipment operation period. The sensor measures fluid temperature T in block 47 and in block 49 sets Tₚ equal to measured temperature T. In block 51 the sensor measures fluid temperature T and fluid condition variable S approximately X minutes after the initial temperature measurement in block 47. In decision block 53, the newly measured temperature T is compared to the previously measured temperature Tₚ to determine if new temperature T is greater than or equal to previous temperature Tₚ, that is, to determine if fluid temperature is not decreasing. If T is not greater than or equal to Tₚ, that is if fluid temperature is decreasing, then method 43 returns to block 49 where Tₚ is set equal to T and continues to block 51 where fluid temperature T and fluid condition variable S are again measured approximately X minutes after the last measurement in block 51. If the determination in block 53 is that temperature T is greater than or equal to temperature Tₚ then in block 55 the measurement S is used in a fluid condition determination before the method returns to block 49. Method 43 continuously repeats until the equipment and sensor are turned “off”.

The use of S shown in block 55 can be as simple as to communicate measurement S, and possibly temperature T, to other electronics where the actual fluid condition determination is made. Use of S can be a relatively complex method that could include further filtering the value S, converting S to an equivalent value using known sensor or measurement values, trending and smoothing the current S or S equivalent value with previously stored S or S equivalent value(s), comparing S or S equivalent value(s) or trends to thresholds, or other methods known in the art to determine a fluid condition.

While method 43 of FIG. 5 is shown to be used in essentially real-time as measurements are being made by a sensor, the present invention can also be used off-line with previously measured and stored fluid temperature and fluid condition values.

Method 43 of FIG. 5 can be run using electronics in the sensor making the temperature measurement T and/or the condition measurement S, or the invention can be run using electronics totally separate from the sensor, but which receives measurements from the sensor(s).

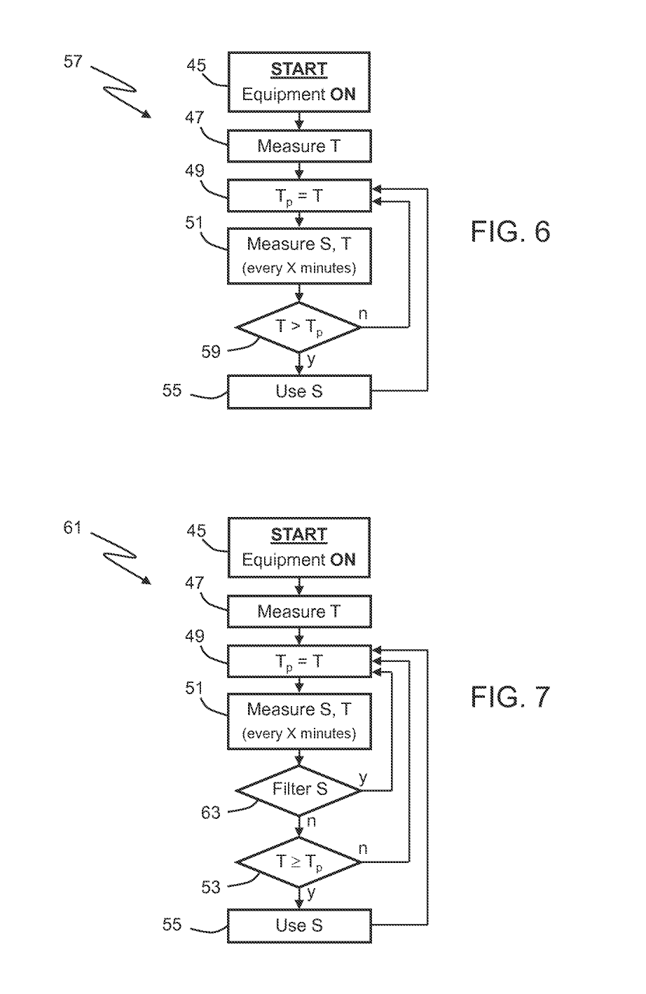

FIG. 6 is a flow chart of a second embodiment 57 of the present invention for filtering measurements of a sensor monitoring the condition of a fluid. For convenience of describing the embodiment, blocks with the same function of those of FIG. 5 are labeled the same. Method 57 begins at block 45 when equipment and sensor are turned “on” at the start of an equipment operation period. Fluid temperature T is measured in block 47 and Tₚ is set equal to T in block 49, after which fluid temperature T and fluid condition variable S are measure in block 51 approximately X minutes after the initial temperature measurement. In decision block 59 newly measured temperature T is compared to previously measured temperature Tₚ to determine if new temperature T is greater than previous temperature Tₚ, that is, to determine if the lubricant temperature is increasing. If T is not greater than Tₚ, that is if the lubricant temperature is not increasing, then method 57 returns to block 49 to repeat the method. If the determination in block 59 is that temperature T is greater than temperature Tₚ then in block 55 the measurement S is used in a fluid condition determination as described with FIG. 5 before the method returns to block 49 with method 57 continuing to repeat until the equipment and sensor are turned “off”.

As describe with reference to method 43 of FIG. 5, method 57 or FIG. 6 does not need to be run in essentially real-time, but can be run using previously stored measurements. Method 57 can be run on electronics in a sensor or in electronics located separate from sensor(s) making and communicating the measurements.

As previously described, the use of S in block 55 in methods 43 and 57 of FIGS. 5 and 6 respectively can include other methods of filtering fluid condition measurements S that are used in addition to the filtering of this method. Additional filtering of the fluid condition measurements, however, does not have to occur after the filtering of this method. FIG. 7 is a flow chart of another embodiment 61 of the present invention where other measurement filtering occurs before the filtering of this method. As before blocks with a function describe previously are label the same. Method 61 starts in block 45 when equipment and sensor are turned “on”. An initial fluid temperature measurement T is made in block 47, Tₚ set equal to T in block 49 and fluid measurements S and T are made in block 51 approximately X minutes after the initial T measurement. A determination is made in block 63 if measurement S is not appropriate for use in a fluid condition determination before the determination of this invention can made in the block 53. As an example, determination in block 63 can be whether measured fluid temperature T is below a threshold temperature and/or if the absolute value of the rate of temperature change is above a threshold rate as was described in the example given in the “Background of the Invention” section. As a second example, determination in block 63 can be whether the measured fluid property is outside the acceptable value for that measurement. In any case, if the determination in block 63 is that measurement S is not an appropriate value for a fluid condition determination then method 61 returns to block 49. If the determination in block 63 is that the measurement S is appropriate, and determination is made in block 53 if current temperature T is greater than or equal to previous temperature Tₚ. If the determination is negative method 61 returns to block 49, and if the determination is positive in block 55 measurement S is used in a fluid condition determination before returning to block 49. Method 61 continuously repeats until the equipment and sensor are turned “off”.

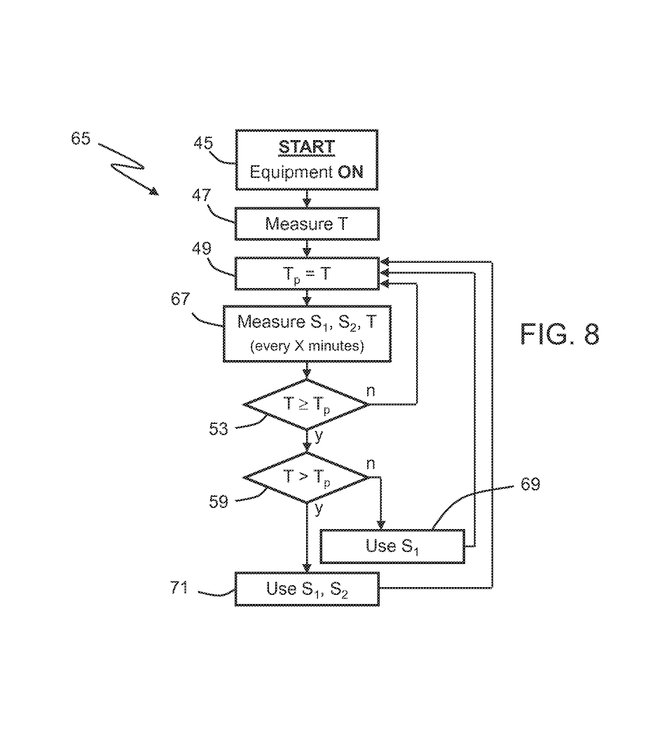

The embodiments 43, 57 and 61 shown in FIGS. 5, 6 and 7 respectively show only one fluid condition measurement being filtered. The invention, however, is not limited to filtering only one fluid condition measurement, but can filter a multitude of fluid condition measurements. FIG. 8 is a flow chart of an embodiment 65 where two fluid condition measurements are made and where each is filtered differently. Method 65 starts in block 45 when equipment and sensor are turned “on”. Fluid temperature T is measured in block 47 and Tₚ is set equal to T in block 49, and approximately X minutes after measuring temperature in block 47, fluid temperature and two fluid condition measurements S₁ and S₂ are made in block 67. The determination is made in block 53 if current fluid temperature T is greater than or equal to previous fluid temperature Tₚ. If the determination is negative, then method 65 returns to block 49. If the determination is positive then in block 59 a determination is made if current temperature T is greater than previous temperature Tₚ. If the determination of block 59 is negative then only fluid condition measurement S₁ is used in a fluid condition determination before method 65 returns to block 49. If the determination of block 59 is positive then both fluid condition measurement S₁ and S₂ are used in fluid condition determinations before method 65 returns to block 49. That is, fluid condition measurement S₂ is used when the fluid temperature is not decreasing, and fluid condition measurement S₁ is only used when fluid temperature is increasing. In any case after method 65 returns to block 49 where the method continues to repeat until the equipment and sensor are turned “off”.

While method 65 of FIG. 8 is shown and described with two different determinations of the present invention being applied to the two fluid condition measurements S₁ and S₂, in another embodiment the same determination, either block 53 or block 59 could be applied to both fluid condition measurements.

Other embodiment could also be shown with more than two sensor measurements.

In the shown embodiments of FIGS. 5, 6, 7 the decision of whether to accept or reject measurements made either for current measured fluid temperature T being greater-than previous measured fluid temperature Tₚ or for current fluid temperature T being greater-than-or-equal-to previous measured fluid temperature Tₚ. In FIG. 8 both decision possibilities are shown. When applying the method of this invention, the choice of which decision option to use is dependent on both the typical operating state of the equipment using the monitored fluid, and on the condition measurement being made. The more steady the equipment operating state, that is the more likely that that current fluid temperature measurement T will be equal to the previous fluid measurement Tₚ, the more appropriate the “greater-than-or-equal-to” decision choice typically becomes to limit the rejection of meaningful information. Conversely the more varied the equipment operating state the decision choice of “greater-than” typically becomes more appropriate. The more dependent the fluid condition measurement is on equipment operating state, the more the decision choice is biased to the “greater-than” decision. Nevertheless, the present invention allows for the choice of either decision when filtering fluid condition measurements, and as will be shown in the following example, both decisions are effective in filtering fluid condition measurements in equipment with varying operating state.

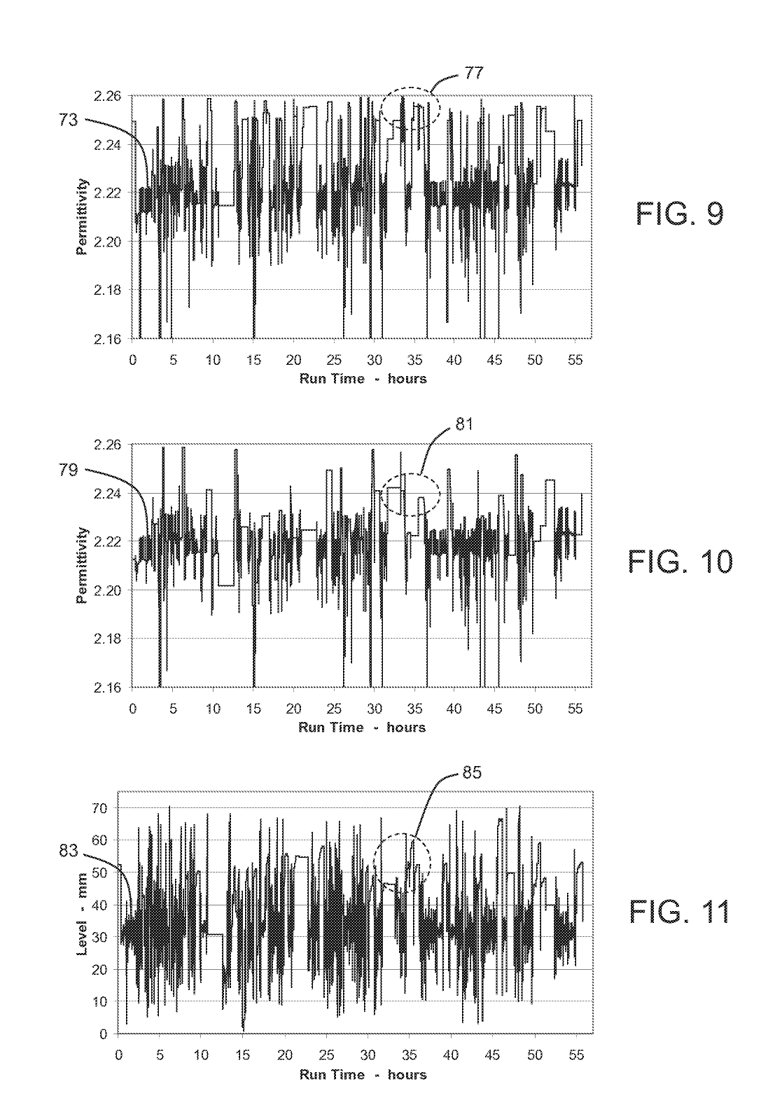

FIGS. 9 and 10 show results of applying method 43 shown in FIG. 5 and method 57 shown in FIG. 6 to permittivity measurements of FIG. 3 respectively. As previously described permittivity measurements of FIG. 3 are already filtered for minimum temperature and maximum temperature rate-of-change. Comparing steady state period 27 of FIG. 3, with the same steady state portions 73 of FIG. 9, and 79 of FIG. 10, use of the “greater-than-or-equal-to” decision in FIG. 9 does not show much reduction in accepted permittivity measurements 73 relative to accepted measurements 27 of FIG. 3, whereas use of the “greater-than” decision in FIG. 10 does show a reduction of accepted permittivity measurements 79. Comparing overall permittivity variance and in particular variance in circles 33, 77 and 81 of FIGS. 3, 9, 10 respectively, the “greater-than” decision of FIG. 10 filters the greatest amount of permittivity variation, while the “greater-than-or-equal-to” decision of FIG. 9 still provides substantial filtering of permittivity variations shown in FIG. 3.

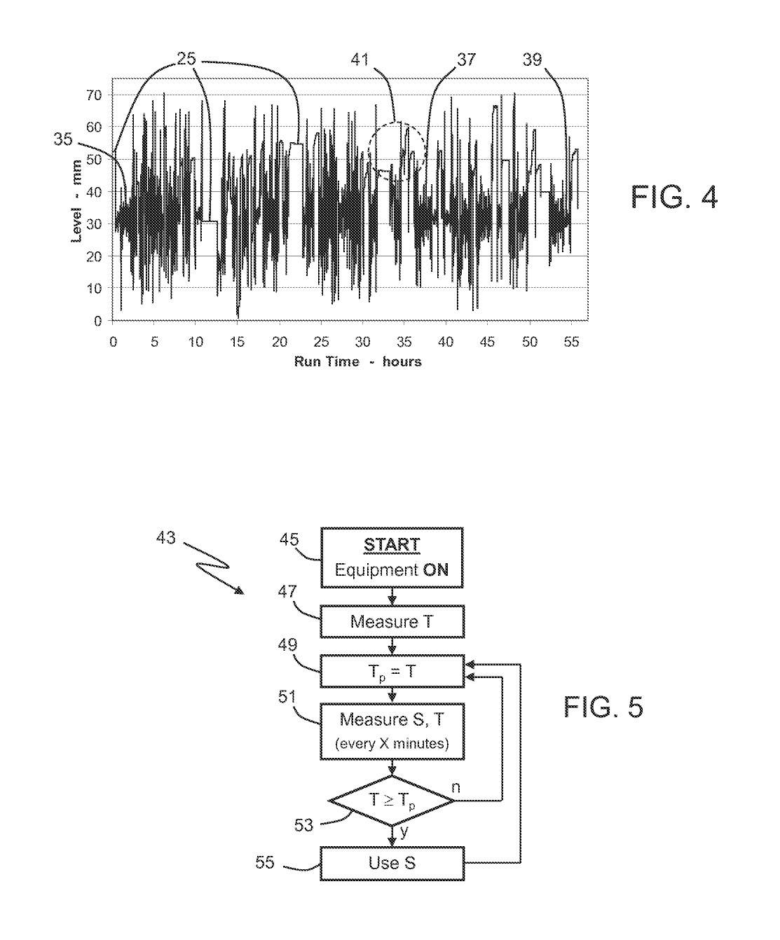

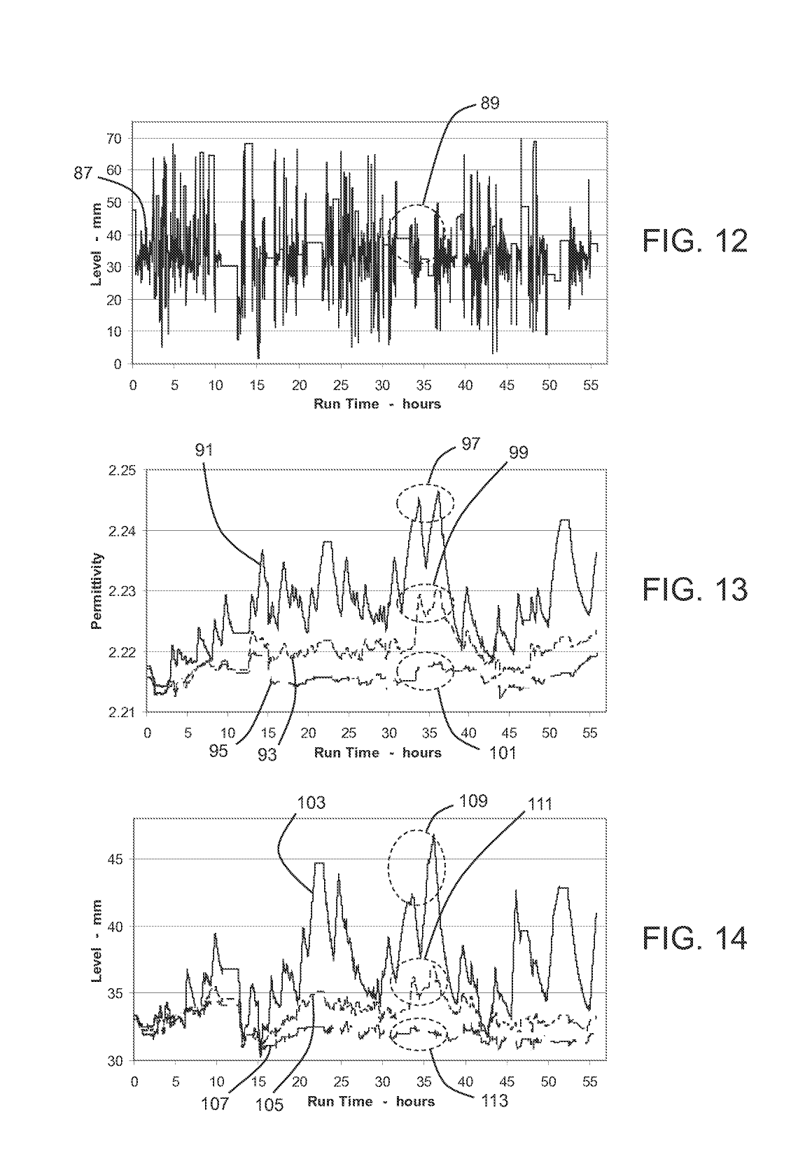

FIGS. 11 and 12 show results of applying method 43 shown in FIG. 5 and method 57 shown in FIG. 6 to level measurements of FIG. 4 respectively, which are already filtered for minimum temperature and maximum temperature rate-of-change. Comparing steady state period 35 of FIG. 4, with the same steady state portions 83 of FIG. 11, and 87 of FIG. 12, use of the “greater-than-or-equal-to” decision again does not show much reduction of accepted measurements 83 in the essentially steady state period, whereas use of the “greater-than” decision does result in an observable level measurement reduction. Comparing overall level variance and in particular variance in circles 41, 85 and 89 of FIGS. 4, 11, 12 respectively, the “greater-than” decision of FIG. 12 filters the greatest amount of level variation, while the “greater-than-or-equal-to” decision of FIG. 11 still provides substantial filtering of level variations shown in FIG. 4.

In a fluid condition determination the use of permittivity measurements of FIGS. 3. 9 and 10 and the level measurements of FIGS. 4, 11 and 12 would typically still be further filtered mathematically when determining a condition trend or when comparing to a condition condemnation threshold. For visual comparison of the effectiveness of the current invention, FIG. 13 is a graphic representation of a simple smoothing filter applied to each of the permittivity measurements shown in FIGS. 3, 9 and 10 and FIG. 14 is a graphic representation of the same smoothing filter applied to each of the level measurements shown in FIGS. 4, 11, and 12. Smoothing started at the fluid change that occurred approximately 740 run hours before the 0 hours shown in FIGS. 2 to 4 and 9 to 14, with 99% of the first accepted measurement after fluid change added to 1% of the next accepted measurement and continuing with 99% percent of that sum and adding 1% of the next accepted measurement until the next fluid chance, which occurred approximately 1,030 hours after the last data shown in the figures.

Referring to FIG. 13, curves 91, 93 and 95 are the smoothed permittivity measurements of FIGS. 3, 9 and 10 respectively. In general, curve 91 would require additional filtering for proper permittivity trending and/or comparison to permittivity condemnation thresholds, whereas curves 93 and 95 show relatively smooth curves and if not for the very large variations that occurred with the original permittivity measurements shown in circle 97, which resulted in the variations in circles 99 and 101 of curves 93 and 95 respectively, both curves 93 and 95 could be diagnosed to show that permittivity did not change during the total 56 hour run period. This no-change diagnosis is consistent with laboratory measured results that showed the amount of condemnation did not change during the period. Hence, while method 57 of the current invention shown in FIG. 6 results in the smoother curve 95 of FIG. 13, method 93 shown in FIG. 5 might still be used if large engine operation variations of the type that caused large temperature variations 15, 17 of FIG. 2 and, thus, the large permittivity variations during the same time 33 of FIG. 3 are not of sufficient magnitude to cause the lubricant condition determination to be in error.

Referring to FIG. 14, curves 103, 105 and 107 are the smoothed level measurements of FIGS. 4, 11 and 12 respectively. In general, curve 103 would require additional filtering for proper level trending and/or comparison to low or high level condemnation thresholds. While curve 105 is significantly smoother than curve 103, the smoothness of curve 107, is needed to clearly show that the lubricant level decreased during the 56 hours of engine operation. This level decrease is consistent with the known rate of lubricant loss during the engine's combustion process. In particular, the progressive reduction of level variations from measurements in circle 109 to those circles 111 and 113 clearly show “greater-than” filter of method 57 in FIG. 6 is best in this example for level condition measurement.

While particular embodiments of the present invention have been shown and described, various combinations, changes and modification may be made therein to meet fluid condition analysis needs of various applications without departing from the invention in its broadest aspects. In addition, while a particular feature of the invention may have been disclosed with respect to only one of several embodiments, such feature may be combined with one or more other features of the other embodiments as may be desired and advantageous for any given or particular application. While only lubricant permittivity and level condition examples have been shown and described for an engine application that operates under varying speeds and load, the present invention is not limited to fluid type, fluid application or fluid condition property. The present invention can be applied to any type of fluid that is measured by any type of sensor including: physical property sensors such as level, viscosity or contaminant sensors; electrical property sensors such as impedance, conductance or permittivity sensors; optical property sensors such as infrared, ultraviolet or visible light sensors; acoustic property sensors such as speed of sound or sound dispersion sensors; or other sensors known in the art. Sensors suitable for use in the methods of the invention include those used in an equipment application that does not operate at steady-state, for example, an industrial or transportation transmission or gearbox, a hydraulic power system, or a dynamic load bearing system, where fluid temperature varies as a function of the operating state.

While in accordance with the Patent statutes, the best mode and preferred embodiment have been set forth, the scope of the invention is not limited thereto, but rather by the scope of the attached claims.

1. A method of filtering condition measurements of a fluid utilized in a piece of equipment comprising the steps of:
I. measuring the temperature of the fluid over time during the operation of the piece of equipment;
II. measuring at least one fluid condition over time during the operation of the piece of equipment;
III. filtering the fluid condition measurements by selecting only fluid condition measurements taken during time periods when:
a. the fluid temperature is increasing; or
b. the fluid temperature is not decreasing;
IV. using the filtered fluid condition measurements in the determination of the condition of the fluid.

2. The method of claim 1 wherein the measured fluid conditions are selected from one or more of the following: a physical property, a chemical property, an electrical property, an optical property, an acoustic property, or combinations thereof.

3. The method of claim 1 wherein the determination of whether the fluid temperature is increasing or not decreasing, is made by comparing the fluid temperature measurement corresponding to the fluid condition measurement in question, to the fluid temperature measurement of the previous corresponding fluid condition measurement, wherein the corresponding fluid temperature measurement is that read during the same equipment operating period that the fluid condition measurement is read.

4. The method of claim 1 wherein the fluid condition measurements are for the determination of one fluid condition.

5. The method of claim 1 wherein the fluid condition measurements are for the determination of multiple fluid conditions.

6. The method of claim 1 wherein fluid condition and temperature are measured by a single sensor.

7. The method of claim 1 wherein fluid condition and temperature are measured by multiple sensors.

8. The method of claim 1 wherein the method is applied in essentially real-time as the measurements are being made.

9. The method of claim 1 wherein the method is applied to measurements stored for later fluid condition determination.

10. The method of claim 1 wherein the method is applied at a location selected from one of the following: at a sensor making a fluid condition measurement, at a sensor making the temperature measurements, at an electronic module that collects essentially real-time fluid condition and temperature measurements, at an electronic module that processes stored fluid condition and temperature measurements, and combinations thereof.

11. The method of claim 1 wherein the method further comprises applying one or more additional means of filtering the fluid condition measurements wherein the one or more additional means of filtering are different from that of step III.
